(19) United States
(12) Patent Application Publication
(10) Pub. No.: US 2006/0233624 A1
(43) Pub. Date: Oct. 19, 2006

(54) Device for selectively stabilizing a rolling assembly

(76) Inventors: Ryan Weber, Palmdale, CA (US); Rebecca Weber, Palmdale, CA (US); Paula Diane Muller, Elk Grove, CA (US)

Correspondence Address: W. Eric Boyd, Esq., 39 Albergar, San Clemente, CA, 92672, US

(21) Appl. No.: 11/107,151

(22) Filed: Apr. 18, 2005

(51) Int. Cl. B64C 1/22

(52) U.S. Cl. 410/80

(57) ABSTRACT

A device for temporarily securing a rolling assembly such as a shopping cart or children's stroller is disclosed. A support base is affixed to a surface such as automobile trunk interior or passenger compartment. A stabilizing arm is adjustably connected to the support base and includes attachment means on a distal end. A user extends the stabilizing arm such that attachment means is proximal the rolling assembly and temporarily connects the attachment means to the rolling assembly. In this manner, the rolling assembly is temporarily stabilized during loading or unloading to prevent unwanted movement.

### BACKGROUND OF THE INVENTION

1. Field of the Invention

The invention relates generally to selectively stabilizing a mobile assembly such as a shopping cart or children's stroller. Specifically, the invention relates to a device that allows a user to secure a shopping cart, stroller or the like while loading or unloading contents therein by use of attachment means on a stabilizing arm, which arm is moveably connected to a support base mounted to the user's motor vehicle.

2. Description of the Prior Art

Mobile devices such as shopping carts and children's strollers are common in society and are a convenient method of transporting items or children over short to medium distances. A typical application of such rolling containers is their use to carry goods from a grocery store to the purchaser's vehicle for subsequent loading into a vehicle.

Difficulty can arise during the loading process when the user is occupied with the placement of items from the rolling container into a vehicle, leaving the rolling container temporarily unattended. Because such rolling containers are typically capable of rolling in any direction, an unaffixed rolling container can potentially roll away from the immediate control of the user due to the slope of a parking lot, a gust of wind or being inadvertently struck by a vehicle, person or other rolling container.

Because small children are often seated in shopping carts, the risk of personal injury and increased liability of the owner of a premises are increased due to loss of control of such carts.

Prior art attempts to address the above problems have included locking wheels or brakes that can be selectively locked by a user. Such locking mechanisms are awkward in application, require too much effort to lock all wheels, require maintenance and are infrequently available.

What is needed is a device that can be installed in a user's vehicle so that individuals who desire the means to stabilize a rolling container may do so without depending on the owner of the rolling container to provide such stabilizing means.

### SUMMARY OF THE INVENTION

A device for allowing a user to temporarily limit the movement of a mobile object such as a shopping cart or children's stroller is disclosed.

The invention may be installed in a vehicle to permit a user to prevent a shopping cart from rolling away by mechanically attaching the cart to the vehicle and effectively using the vehicle as a fixed anchor point.

The invention generally comprises a support base mounted in a passenger compartment, trunk and/or cargo bed of a vehicle. A stabilizing arm is preferably rotatably mounted to the support base such that the stabilizing arm can swing out from a first position to a second position but may be selectively fixed in a locked position relative to the support base.

In a first aspect of the invention, the stabilizing arm is foldable by means of a pivoting or hinge mechanism to facilitate storage.

In a second aspect of the invention, the stabilizing arm length may be varied by means of a telescoping configuration to facilitate storage.

In a third embodiment of the invention, the stabilizing arm further comprises horizontally depending lock arms slideably adjustable on, and selectively perpendicular to, the stabilizing arm for the receiving of a portion of a rolling container.

In a fourth embodiment of the invention, the distal end of the stabilizing bar comprises attachment means for the selective attachment to a rolling container. Many attachment means such as a clamp, strap, clip hook and the like may be desirably utilized which will be discussed below. These and additional embodiments are disclosed as is discussed below.

While the invention has or will be described for the sake of grammatical fluidity with functional explanations, it is to be expressly understood that the claims of the application, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

### BRIEF DESCRIPTION OF THE DRAWINGS

FIGS. 1a, 1b and 1c are plan views of the instant inventions installed and in a retracted and extended position.

FIGS. 2a and 2b are views of two preferred embodiments of the support base of the present invention.

FIGS. 3a, 3b and 3c show the connection arm of the present invention in a fixed length, hinged length and telescoping length, respectively.

FIG. 4 illustrates a preferred embodiment of the attachment means of the invention comprised of two pivoting opposing hooked clamp members which are moveable and inwardly biased toward each other by use of a spring mechanism.

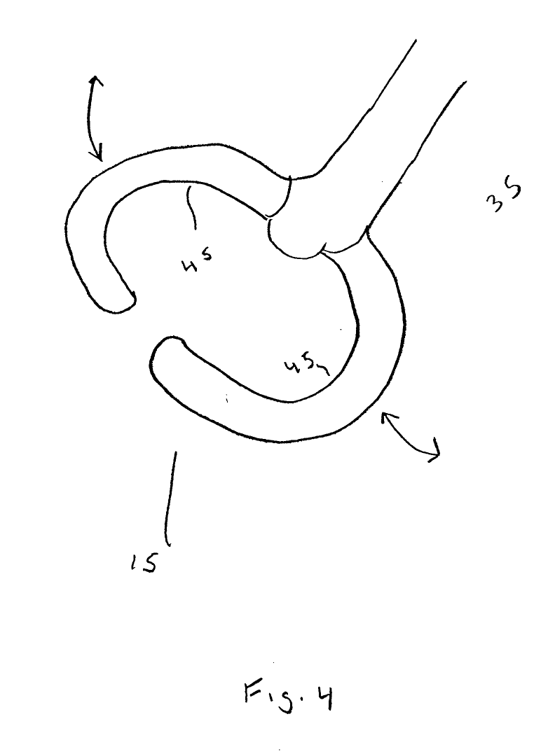

FIG. 5 shows the connection arm of the present invention comprising two foldable lock arms, one of which is biased toward the other by use of a spring or elastic member.

The invention and its various embodiments can be better understood by turning to the following detailed description of the preferred embodiments which are presented as illustrated examples of the invention that will be defined in the claims. It is expressly understood that the invention as will be defined by the claims may be broader than the illustrated embodiments described below.

### DESCRIPTION OF THE PREFERRED EMBODIMENTS

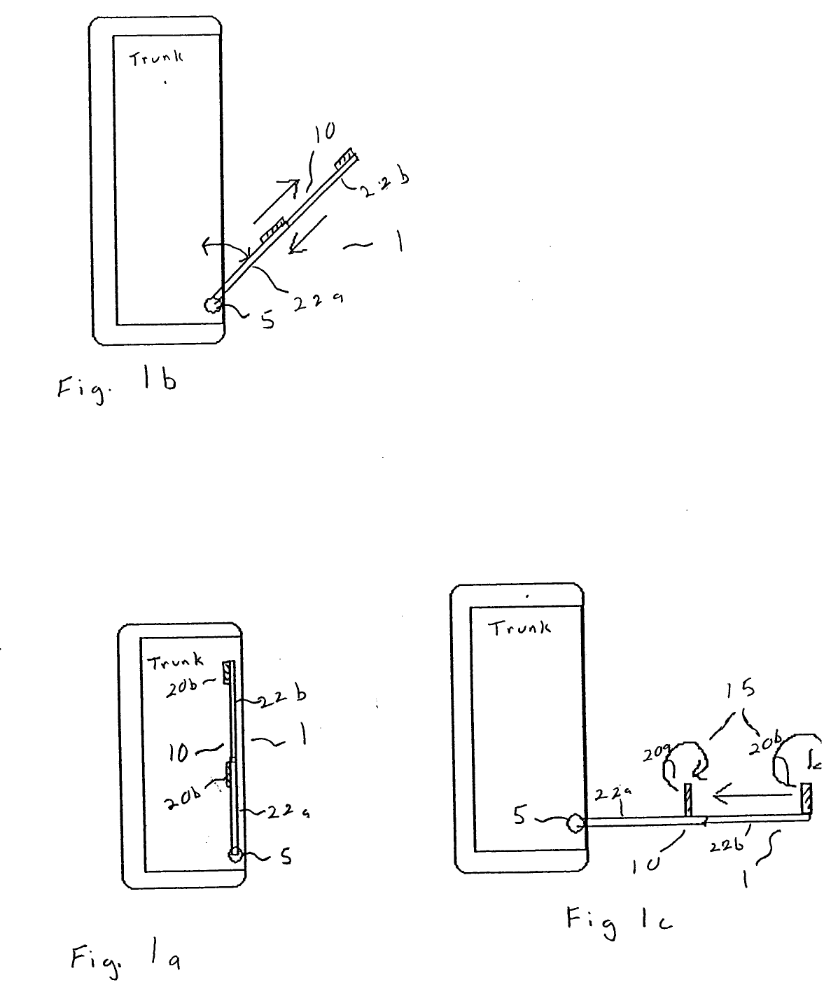

Turning now to the figures wherein like numerals identify like elements among the several views, FIGS. 1a, 1b, and 1c show the major elements of a preferred embodiment of the securing device 1 of the disclosed invention installed in the storage trunk of a vehicle including a support base 5, a stabilizing arm 10, and attachment means 15, here comprised of a pair of folding lock arms 20a and 20b.

Support base 5, stabilizing arm 10, and locking arms 20a and 20b are preferably made from metal or a polymer of suitable strength and rigidity to withstand substantial lateral loads as may be encountered in stabilizing a fully loaded rolling assembly which material selection and design are well understood by those skilled in the materials and mechanical design arts.

As illustrated in FIG. 1b, stabilizing arm 10 is rotatably attached to support base 5 whereby stabilizing arm 10 can be swung about the axis defined by support base 5. In this manner, a user may rotate stabilizing arm 10 within or out of the trunk when desired. It is to be specifically noted that use of the disclosed invention is not limited to the trunk of a vehicle but may be installed in the passenger compartment of a vehicle or at any fixed and stable location where the temporary affixing of a rolling container is desired.

Support base 5 is mechanically connected to the vehicle by means of an adhesive, screws, bolts, weld or equivalent connection means. Support base 5 is configured so as to receive stabilizing arm 10 to rotate about an axis.

In an alternative embodiment, not shown, a locking mechanism such as a screw clamp, cam lock, friction lock, collet assembly or other equivalent locking means is provided to allow the selective locking of the stabilizing arm 10 position relative to support base 5 in a desired position.

An alternative preferred embodiment further comprises means to selectively adjust the height of stabilizing arm 10 relative to support base 5 such as cooperative ratcheting mechanisms, interlocking cooperative structures, friction fittings, locking pin or threaded compression locking means and the like as is well-known in the mechanical design arts.

As seen in the embodiment shown in FIGS. 1b and 1c, lock arms 20a and 20b are preferably pivotably mounted on stabilizing arm 10 such as by hinges so that a user may selectively fold or unfold them upon stabilizing arm 10. When the lock arms are outwardly extended, they receive and grip a portion of the external surface of a rolling container and retain it therebetween.

Stabilizing member 10 may comprise adjustable telescoping portions 22a and 22b such that the relative distance between respective lock arms 20a and 20b can be varied by a user.

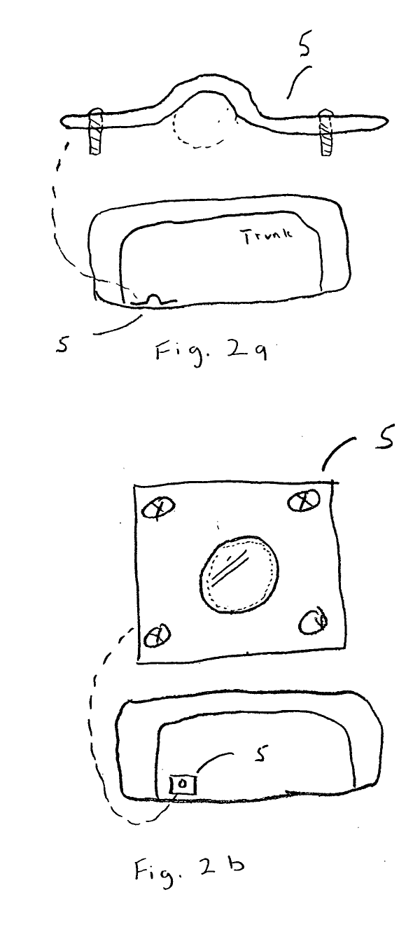

FIGS. 2a and 2b show two preferred embodiments of support base 5, for attachment to a vertical surface of a vehicle and a horizontal surface of a vehicle respectively.

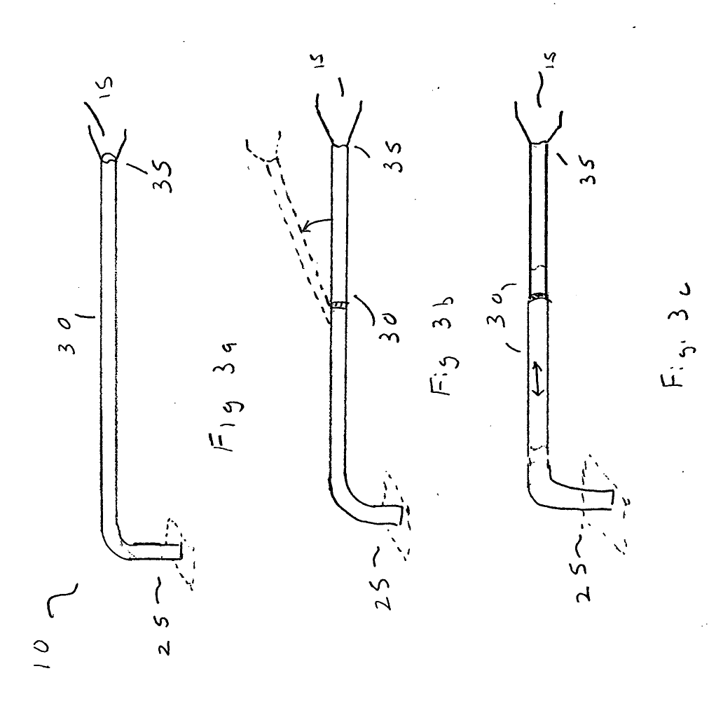

FIGS. 3a, 3b and 3c illustrate preferred embodiments of the stabilizing member 10 of the invention.

FIG. 3a shows a stabilizing arm in a fixed length configuration wherein the stabilizing member is comprised generally of an upwardly depending shaft 25 and an outwardly depending connection arm 30. Connection arm 30 comprises a distal end 35 with attachment means 15 disposed thereon for the securing of a rolling container.

Shaft 25 is angularly disposed to connection arm 30 and both are in substantial perpendicular orientation to each other. In this manner, shaft 25 is in rotatable connection with support base 5 such that connection arm 30 can swing in a horizontal plane about the vertical axis defined by shaft 25.

FIG. 3b discloses an alternative preferred embodiment wherein connection arm 30 is comprised of two or more hinged segments which allow the convenient storage of the connection arm 30 in a trunk or passenger compartment of a vehicle. The hinged segments are preferably lockable to provide rigidity along the length of connection arm 30.

FIG. 3c illustrates yet a third preferred embodiment wherein connection arm 30 is comprised of two or more tubular telescoping segments to facilitate storage as noted above.

Distal end 35 further comprises attachment means 15 to allow a user to selectively attach and detach a rolling container to connection arm 30.

A variety of attachment means 15 may desirably be adopted in the present invention. In a preferred embodiment, attachment means 15 comprises opposing clamp members 45, at least one of which members are inwardly biased toward the other by use of spring or elastic means. Clamp members 45 are used to selectively attach stabilizing arm 10 to a rolling assembly, such as on a handle of a cart. Alternative embodiments include, without limitation, alligator clips, claw means, C-clips, carabineers or expandable furcations configured to allow attachment to a rolling assembly.

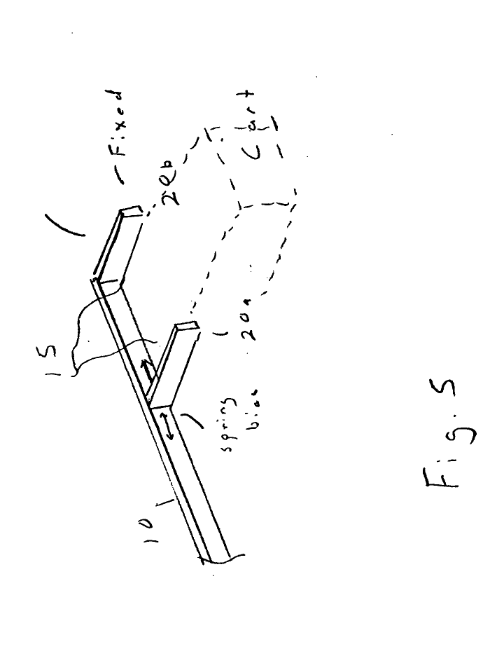

As illustrated in an alternative preferred embodiment of FIG. 5, attachment means 15 comprises lock arms 20a and 20b provided on stabilizing arm 10 which are spring-biased so as to be inwardly urged to selectively secure a rolling assembly.

Attachment means 14 may further desirably comprises strap means such as VELCRO® as is available from Velcro, Inc., buckle means, rope, mechanical snap or other equivalent attachment means as is well known in the mechanical arts, which strap means may conveniently used to attach to a rolling assembly.

Use of the above-disclosed invention is relatively simple. A user accesses securing device 1 at the vehicle or other installation location and raises stabilizing arm 10 to the desired height, if so configured. Stabilizing arm 10 is rotated and extended such that attachment means 15 on distal end 35 is proximal the desired rolling assembly. Attachment means 15 are affixed or secured to the rolling assembly to minimize movement of the rolling assembly. When the user no longer desires the rolling assembly be secured, attachment means 15 are disconnected from the rolling assembly, and the stabilizing arm rotated and retracted back into its original position for later use.

Many alterations and modifications may be made by those having ordinary skill in the art without departing from the spirit and scope of the stabilizing invention. Therefore, it must be understood that the illustrated embodiments have been set forth only for the purpose of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the stabilizing device, its elements and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter for the stabilization device as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A securing device for limiting movement of a mobile assembly comprised of:
a stabilizing member connected to a vehicle; said stabilizing member having a distal end;
attachment means connected to said distal end for the selective securing of a mobile object.

2. A securing device for limiting movement of a mobile assembly comprised of:
a support base;
a stabilizing member comprised of an upwardly depending shaft and an outwardly depending connection arm having a distal end;
said shaft angularly disposed to said connection arm;
said shaft rotatably attached to said support base;
a plurality of lock arms pivotably connected to said stabilizing member whereby said plurality of lock arms may be variably angularly disposed to said stabilizing member.

3. The device of claim 2 whereby at least one of said plurality of lock arms is slideably attached to said stabilizing member.

4. A securing device for limiting movement of a mobile object comprised of:
a support base;
an stabilizing member comprised of an upwardly depending shaft and an outwardly depending connection arm having a distal end;
said shaft angularly disposed to said connection arm;
said shaft rotatably attached to said support base;
attachment means connected to said distal end for the selective securing of a mobile object.

5. The device of claim 4 wherein said connection arm is comprised of two or more telescoping segments.

6. The device of claim 4 wherein said connection arm is comprised of a first segment pivotably connected to a second segment whereby said connection arm may be folded.

7. The device of claim 4 wherein said attachment means comprises a pair of clamp members.

8. The device of claim 4 wherein said attachment means comprises a plurality of hooked projections.

9. The device of claim 4 wherein said attachment means comprises strap securing means.

10. The device of claim 4 further comprising locking means to selectively prevent movement of said stabilizing member relative to said support base.

11. The device of claim 4 wherein said support base is mounted to a motor vehicle.

12. The device of claim 4 wherein said support base is mounted in the passenger compartment of a motor vehicle.

13. The device of claim 4 wherein said support base is mounted in the trunk of a motor vehicle.
